(19) United States
(12) Patent Application Publication
(10) Pub. No.: US 2016/0136039 A1
(43) Pub. Date: May 19, 2016

(54) Infant Soothing Device

(71) Applicant: Kay Spence, Conley, GA (US)

(72) Inventor: Kay Spence, Conley, GA (US)

(21) Appl. No.: 14/933,702

(22) Filed: Nov. 5, 2015

Related U.S. Application Data
(60) Provisional application No. 62/079,756, filed on Nov. 14, 2014.

(51) Int. Cl. A61H 23/00

(52) U.S. Cl. CPC A61H 23/004; A61H 2201/1207

(57) ABSTRACT

An infant soothing device configured to provide a comforting and soothing touch to ease an infant to sleep. The infant soothing device includes an arm portion having a hand portion configured to be placed against an infant. The arm portion is attached to an attachment arm via a maneuverable joint. The attachment arm is removably attached to a supporting structure, such as a crib or a stroller via a fastener thereon. The arm portion includes an actuating assembly that is configured to actuate the arm portion in several modes of operation that are adapted to promote sleep for an infant. The actuating assembly includes a control panel that is electrically connected to a motor that is configured to provide the modes of operation. The control panel includes a plurality of switches that allow a user to activate and deactivate the actuating assembly and the modes of operation.

### CROSS REFERENCE TO RELATED APPLICATION

This application claims the benefit of U.S. Provisional Application No. 62/079,756 filed on Nov. 14, 2014. The above identified patent application is herein incorporated by reference in its entirety to provide continuity of disclosure.

### FIELD OF THE INVENTION

The present invention relates to infant accessories. More particularly, the present invention provides an infant soothing device that includes an arm portion that is configured to provide a comforting and soothing touch to an infant to ease the infant to sleep. The arm portion is actuated by a motor and includes several modes of operation that can be initiated by a user.

### BACKGROUND OF THE INVENTION

Typically, when children are sleeping or napping, these are precious moments for a parent or caregiver to relax and decompress. However, putting an infant to sleep is not always easy, and can be challenging. These struggles with the infant are often characterized by fits and fights, which often can be taxing and take a toll on any parent or caregiver. One of the most helpful ways of putting kids to bed is to establish a routine. Generally, a routine involves establishing a bed time and improving the sleep environment to eliminate any distractions that may hinder him or her from falling asleep.

One of the hardships of establishing a routine, however, is that many infants require a soothing and comforting touch from their parent or caregiver for an extended period of time in order to fall asleep. These parents or caregivers are often forced to stand by a bed or a crib for extended periods of time massaging their infant's torso or back to ease him to sleep. This process can be taxing, and therefore, there exists a need for a device that mimics the soothing and comforting touch of a parent or caregiver to alleviate the stress of placing an infant to bed.

Devices have been disclosed in the prior art that relate to baby soothing devices. These include devices that have been patented and published in patent application publications. Some of these devices disclose a crib mounted baby soothing device having a telescoping bracket adapted to attach to the rungs of a crib, an arm portion, a hand portion, and a ball and socket motor adapted to move the hand in either up and down or circular motions. Other devices provide a crib-mounted machine that is adapted to move a hand-like member in a motion to simulate the baby being patted on the behind. These devices however fail to provide an infant soothing device comprising an arm portion having a hand portion that can operate in various modes to soothe an infant, wherein the arm portion can be removably secured to a support via a fastener.

The present invention provides an infant soothing device including an arm portion having a hand portion configured to provide a soothing and comforting touch to an infant to promote sleep. The arm portion is attached to an attachment portion via a maneuverable joint. The attachment portion is also configured to be removably attached to a support structure, such as a crib, or a stroller, via a fastener. The arm portion includes an actuating assembly that is configured to actuate the arm portion and hand portion in several modes of operation. These modes of operation are initiated by a motor and include patting, massaging, and stroking. The actuating assembly includes a control panel that allows a user to select and change the modes of operation as desired.

It is therefore submitted that the present invention is substantially divergent in design elements from the prior art, and consequently it is clear that there is a need in the art for an improvement to infant soothing devices. In this regard, the instant invention substantially fulfills these needs.

### SUMMARY OF THE INVENTION

In view of the foregoing disadvantages inherent in the known types of infant soothing devices now present in the prior art, the present invention provides an infant soothing device, wherein the same can be utilized for mimicking a comforting touch of a caregiver to allow a caregiver to sleep, while also promoting sleep for the infant.

It is therefore an object of the invention to provide a new and improved infant soothing device that has all of the advantages of the prior art and none of the disadvantages.

Another object of the present invention is to provide a new and improved infant soothing device including an attachment portion attached to an arm portion via a maneuverable joint.

Yet another object of the present invention is to provide a new and improved infant soothing device, wherein said attachment portion includes a fastener configured to removably attach to a support structure.

Still yet another object of the present invention is to provide a new and improved infant soothing device, wherein said arm portion includes a hand portion configured to be placed against an infant's torso or back.

A further object of the present invention is to provide a new and improved infant soothing device, wherein the arm portion supports an actuating assembly having a motor configured to actuate said arm portion and said hand portion in various modes of operation.

Yet a further object of the present invention is to provide a new and improved infant soothing device, wherein said several modes of operation including patting, massaging, and stroking.

An additional object of the present invention is to provide a new and improved infant soothing device, wherein said actuating assembly includes a control panel configured to activate said actuating assembly and the several modes of operation.

Still yet another object of the present invention is to provide a new and improved infant soothing device, wherein the device may be readily fabricated from materials that permit relative economy and are commensurate with durability.

Other objects, features, and advantages of the present invention will become apparent from the following detailed description taken in conjunction with the accompanying drawings.

### BRIEF DESCRIPTIONS OF THE DRAWINGS

Although the characteristic features of this invention will be particularly pointed out in the claims, the invention itself and manner in which it may be made and used may be better understood after a review of the following description, taken in connection with the accompanying drawings wherein like numeral annotations are provided throughout.

FIG. 1 illustrates a side perspective view of the infant soothing device.

FIG. 2 illustrates a side perspective view of the infant soothing device as removably attached to a support structure.

FIG. 3 shows a schematic diagram of the actuating assembly of the infant soothing device.

### DETAILED DESCRIPTION OF THE INVENTION

Reference is made herein to the attached drawings. Like reference numerals are used throughout the drawings to depict like or similar elements of the infant soothing device. For the purposes of presenting a brief and clear description of the present invention, the preferred embodiment will be discussed as used for providing a comforting touch for infants to promote sleep. The figures are intended for representative purposes only and should not be considered to be limiting in any respect.

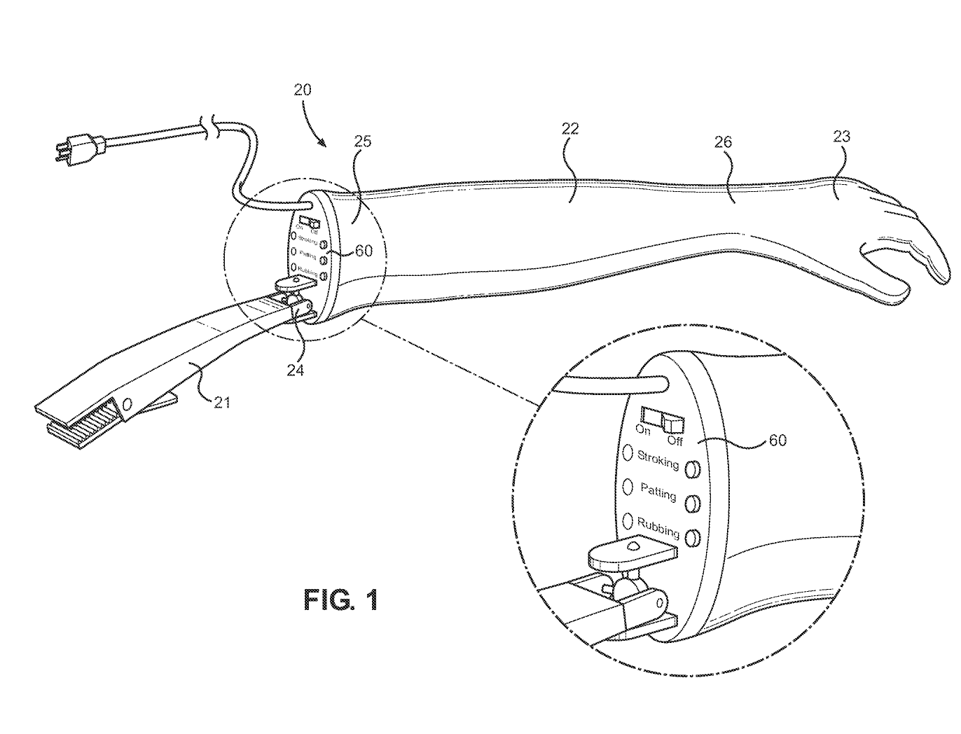

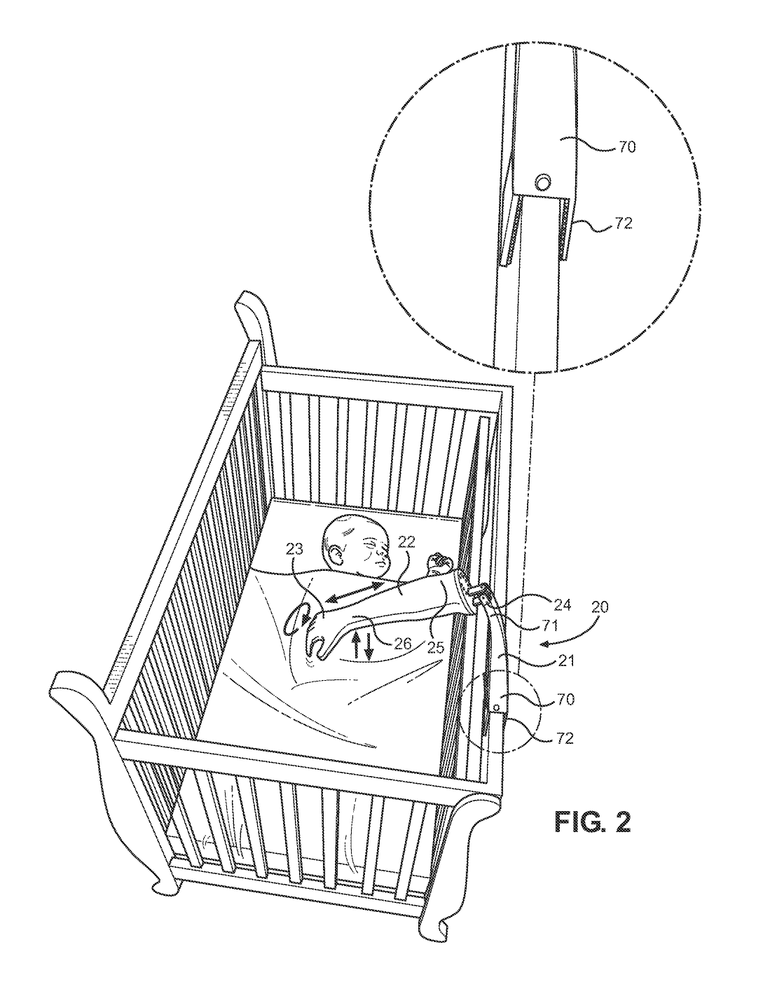

Referring now to FIGS. 1 and 2, there are shown a pair of side perspective views of the infant soothing device. The infant soothing device 20 is configured to mimic the comforting touch of a caregiver in order to soothe infants and other young children. In this way, the infant soothing device 20 allows these infants to fall asleep faster and more peacefully. The infant sooth device 20 comprises an attachment portion 21 that is attached to an arm portion 22. The arm portion 22 includes a hand portion 23 that is configured to be placed against an infant. It is contemplated that the hand portion 23 is preferably placed against an infant's back or stomach. The hand portion 23 is substantially hand-shaped including a palm portion and five finger portions that extend therefrom. Preferably, the five finger portions are partially curved to provide a gentle touch.

The arm portion 22 includes an actuating assembly having an internal motor configured to provide several modes of operation. These modes of operation allow for the hand portion 23 to be moved in motions such as patting, massaging, and stroking. These modes of operation allow for the infant to fall asleep without the need of a caregiver, thereby allowing the caregiver to receive proper rest. The arm portion 22 is movably attached to the attachment portion 21 via a maneuverable joint 24, which allows for the arm portion 22 and the hand portion 23 to provide various modes of operation.

The arm portion 22 includes a first end 25 and a second end 26, wherein the first end 25 is attached to the attachment portion 21 via the maneuverable joint 24. In some embodiments, the arm portion 22 comprises a telescopic configuration so that it can be extended to a desired length. In alternate embodiments, the arm portion 22 comprises a fixed length. The second end 26 includes the hand portion 23. The maneuverable joint 24 is configured to allow for the arm portion 22 to be moved in a variety of motions including, but not limited to, vertical motions, horizontal motions, and circular motions. Preferably, the maneuverable joint 24 is a ball and socket joint, however, other maneuverable joints, such as a universal joint that are suitable for achieving the advantages described in this present disclosure are likewise contemplated.

The internal motor is configured to actuate the arm portion 22 upwardly and downwardly in relation to the attachment portion 21 to provide the patting mode of operation. The arm portion 22 is actuated in circular motion on an infant's back or torso to provide for the massaging mode of operation. Further, the arm portion 22 is configured to vibrate in the massaging mode of operation in order to provide additional massaging effects. The massaging mode of operation may be calibrated so as to provide various levels of force or intensity. Finally, the first end 25 of the arm portion 22 is configured to be actuated side to side to allow for the hand portion 23 to provide for the stroking mode of operation. The internal motor is electrically connected to a control panel 60 disposed on an outer face of the arm portion 22. In this way, the user is provided the ability to select and change the mode of operation as desired.

The attachment portion 21 includes a proximal end 70 and a distal end 71, wherein the proximal end 70 includes a fastener 72 and the distal end 71 is maneuverable attached to the first end 25 of the arm portion 22 via the maneuverable joint 24. The fastener 72 is configured to allow for the infant soothing device 20 to be removably attached to a support structure such as a stroller, a crib, or other similar items. Preferably, the fastener 72 is a mounting bracket that is configured to removably attach to the aforementioned items. The mounting bracket is substantially U-shaped to allow for removable attachment. It is contemplated that those of ordinary skill in the art will immediately recognize a variety of other suitable fasteners that achieve the results and advantages described herein; these variations and modifications are deemed within the scope and spirit of the inventive embodiments of the present invention.

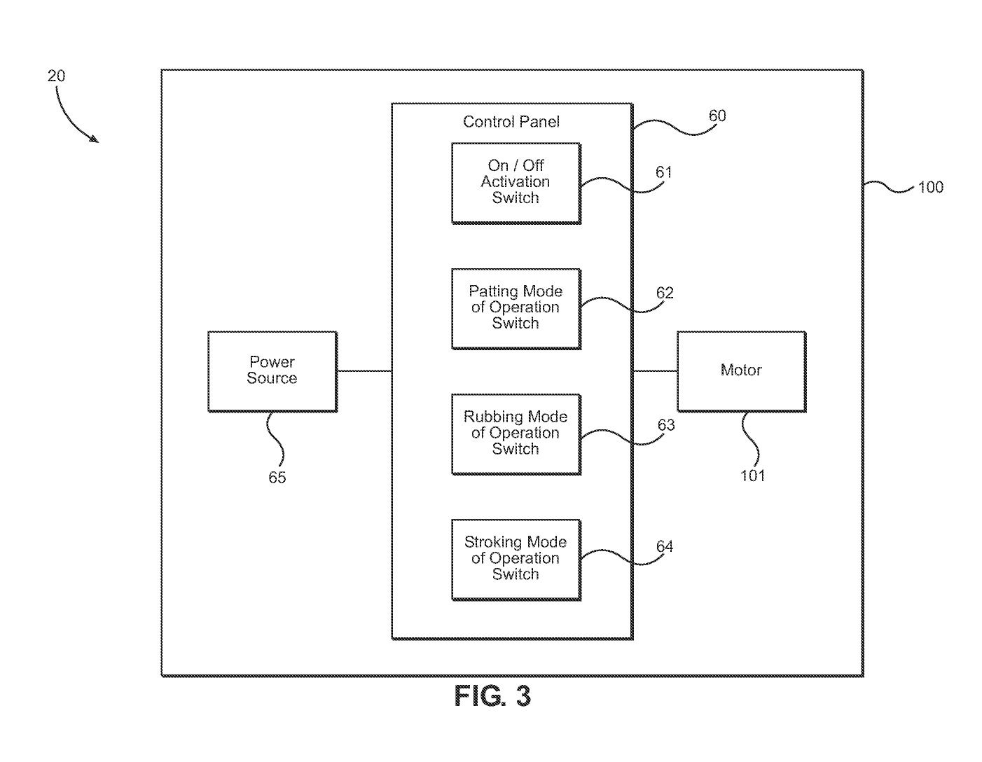

Referring now to FIG. 3, there is shown a schematic diagram of the infant soothing device 20. The infant soothing device 20 includes an actuating assembly 100 that allows for the motor 101 to actuate the arm portion and hand portion in several modes of operation. The actuating assembly 100 includes the control panel 60 that is configured to allow a user to choose the mode of operation for the infant soothing device 20. The control panel 60 includes an on/off activation switch 61, a patting mode of operation switch 62, a massaging mode of operation switch 63, and a stroking mode of operation switch 64. The on/off activation switch 61 is electrically connected to a power source 65 to provide voltage to operate the infant soothing device. Preferably, the power source 65 comprises one or more disposable or rechargeable batteries.

The switches 62, 63, 64 are electrically connected to the motor 101 and are configured to allow a user to select a mode of operation. The switch 62 is configured to activate and deactivate the patting mode of operation. The switch 63 is configured to activate and deactivate the massaging mode of operation. The switch 64 is configured to activate and deactivate the stroking mode of operation. It is contemplated that those or ordinary skill in the art will readily envision other suitable modes of operation that are appropriate for soothing an infant. It is further contemplated that these additions, modifications, and variations include their own respective switches on the control panel that allow for the activation and deactivation of the envisioned mode of operation.

It is therefore submitted that the instant invention has been shown and described in what is considered to be the most practical and preferred embodiments. It is recognized, however, that departures may be made within the scope of the invention and that obvious modifications will occur to a person skilled in the art. With respect to the above description then, it is to be realized that the optimum dimensional relationships for the parts of the invention, to include variations in size, materials, shape, form, function and manner of operation, assembly and use, are deemed readily apparent and obvious to one skilled in the art, and all equivalent relationships to those illustrated in the drawings and described in the specification are intended to be encompassed by the present invention.

Therefore, the foregoing is considered as illustrative only of the principles of the invention. Further, since numerous modifications and changes will readily occur to those skilled in the art, it is not desired to limit the invention to the exact construction and operation shown and described, and accordingly, all suitable modifications and equivalents may be resorted to, falling within the scope of the invention.

I claim:

1) An infant soothing device, comprising:
an arm portion having a first end and a second end, wherein the first end includes a hand portion configured to be placed against an infant's back or torso to provide a comforting touch and promote sleep;
an attachment portion movably connected to the second end of the arm portion via a maneuverable joint, wherein the attachment portion is configured to be removably fastened to a support structure;
an actuating assembly enclosed within said arm portion, the actuating assembly comprising a motor configured to actuate the arm portion and the hand portion.

2) The infant soothing device of claim 1, wherein the actuating assembly is adapted to move the arm portion and the hand portion in an up and down motion to mimic a patting motion.

3) The infant soothing device of claim 1, wherein the actuating assembly is adapted to move the arm portion and the hand portion in a side to side motion to mimic a massaging motion.

4) The infant soothing device of claim 1, wherein the actuating assembly is adapted to move the arm portion and the hand portion in a circular pattern so as to mimic a stroking motion.

5) The infant soothing device of claim 1, wherein:
said actuating assembly further comprises a control panel having a plurality of switches electrically connected to said motor;
wherein said plurality of switches is configured to provide voltage to said actuating assembly.

6) The infant soothing device of claim 5, wherein said plurality of switches include:
an on/off activation switch;
a patting mode of operation switch;
a massaging mode of operation switch; and
a stroking mode of operation switch.

7) The infant soothing device of claim 1, wherein said actuating assembly further includes a power source.

8) The infant soothing device of claim 1, wherein the attachment portion comprises a mounting bracket for securement to the support structure.

9) The infant soothing device of claim 1, wherein said maneuverable joint comprises a ball and socket joint.

10) The infant soothing device of claim 1, wherein said maneuverable joint comprises a universal joint.
